(19) United States
(12) Patent Application Publication
(10) Pub. No.: US 2015/0292723 A1
(43) Pub. Date: Oct. 15, 2015

(54) LED LAMP

(71) Applicant: Shenzhen Yaorong Technology Co., Ltd., Shenzhen (CN)

(72) Inventors: HUAN HUAN YU, Shenzen (CN); YING YONG, Shenzen (CN)

(21) Appl. No.: 14/683,582

(22) Filed: Apr. 10, 2015

(30) Foreign Application Priority Data
Apr. 11, 2014 (CN) 201420175513.1

(51) Int. Cl. F21V 23/02; F21S 8/00; F21K 99/00; F21V 31/00; F21V 29/76; F21V 5/04

(52) U.S. Cl. CPC F21V 23/023; F21V 29/76; F21V 5/048; F21K 9/50; F21V 31/005; F21S 8/036; F21Y 2101/02

(57) ABSTRACT

This invention discloses a LED lamp, which comprises a radiator; a power supply having a power supply box; and a plurality of LED light sources electrically connected with the power supply; wherein the power supply is installed at the back of the radiator; and the power supply is covered by the power supply box which is fixedly secured on the back of the radiator. One end of the power supply box is movably connected with one end of the back of the radiator, and the other end of the power supply box is fixedly secured to the other end of the back of the radiator by fasteners. The LED lamp further comprises a lens module plate covering the LED light sources and sealing by a waterproof ring. This LED lamp can be easily dismounted and installed, whose structure is concise. And The LED lamp has the advantages of good waterproof effect and good heat dissipation, which can be extensively utilized for lighting.

### TECHNICAL FIELD OF THE INVENTION

The instant invention relates to the field of light fixture, and more particularly, to an LED lamp.

### BACKGROUND OF THE INVENTION

The LED lamp in prior art is poor in heat dissipation and sealing property, and the illumination of the LED lamp in prior art is also not homogenous.

For the existing LED lamps, the power supply is not easily dismounted and installed. Once it requires test, repair or replacement, it is necessary to open the upper and lower covers of the LED lamp to take out the power supply, which is fairly troublesome and time-consuming.

In addition, the lenses in the existing LED lamp are individual lens, and the glass plate is used for separating the lens from the external part and preventing contact. Although it can achieve the waterproof purpose, the structure is not concise.

In addition, the existing LED lamp have poor heat dissipation performance.

### SUMMARY OF THE INVENTION

The object of the invention is to solve the above defects, providing a LED lamp which has the advantage of ease of dismounting and installment of the power supply, concise structure, fine heat dissipation and fine illumination effect, which can effectively resolve such problems of existing technology as inconveniently dismounting and installing the power supply, non-concise structure, heat dissipation performance, poor illumination effect and so on.

To resolve these technical problems, the invention is carried out by the following technical solutions:

An LED lamp which comprises:

a radiator;

a power supply having a power supply box; and

a plurality of LED light sources electrically connected with the power supply; wherein the power supply is installed at the back of the radiator; and

the power supply is covered by the power supply box which is fixedly secured on the back of the radiator.

According to one embodiment of the invention, one end of the power supply box is movably connected with one end of the back of the radiator, and the other end of the power supply box is fixedly secured to the other end of the back of the radiator by fasteners.

According to one embodiment of the invention, one end of the power supply box is movably connected with one end of the back of the radiator via the rotating shaft.

According to one embodiment of the invention, the power supply box is provided with the installation hole for installing the LED lamp on a wall.

According to one embodiment of the invention, the power supply box is provided with the installation hole for installing the LED lamp on a wall.

According to one embodiment of the invention, the power supply box is provided with the installation hole for installing the LED lamp on a wall.

According to one embodiment of the invention, the LED lamp also comprise:

a lens module plate

a heat conduction secured on the bottom of the radiator plate, on which the LED light sources are homogenously distributed; and wherein

the lens quantity in the lens module plate is equal to the quantity of LED light sources;

the LED light sources is covered by the lens module plate, and is sealed by a waterproof ring, in which one LED light source is covered one lens cover in turn; and

the lens module plate is secured to bottom of the radiator.

According to one embodiment of the invention, the LED lamp also comprise:

a lens module plate;

a heat conduction secured on the bottom of the radiator plate, on which the LED light sources are homogenously distributed; and wherein

the lens quantity in the lens module plate is equal to the quantity of LED light sources;

the LED light sources is covered by the lens module plate, and is sealed by a waterproof ring, in which one LED light source is covered one lens cover in turn; and

the lens module plate is secured to bottom of the radiator.

According to one embodiment of the invention, the LED lamp also comprise:

a lens module plate

a heat conduction secured on the bottom of the radiator plate, on which the LED light sources are homogenously distributed; and wherein

the lens quantity in the lens module plate is equal to the quantity of LED light sources;

the LED light sources is covered by the lens module plate, and is sealed by a waterproof ring, in which one LED light source is covered one lens cover in turn; and

the lens module plate is secured to bottom of the radiator.

According to one embodiment of the invention, the lens in the lens module plate is polarized light distribution lens.

According to one embodiment of the invention, the radiator is provided with a plurality of holes for interconnecting the lower and upper parts of the radiator.

According to one embodiment of the invention, the radiator is provided with a plurality of radiating fins spaced by gaps therebetween.

According to one embodiment of the invention, the radiator is made of aluminum or copper.

According to one embodiment of the invention, the power supply is provided with a lightning arrester.

Compared with the existing technology, the invention has the following beneficial effects:

1) Since the power supply of LED lamp is installed at the back of the radiator, one end of the power supply box is movably connected with one end of the back of the radiator, it is convenient to open and is easy for dismounting and installing the power supply;

2) The LED lamp comprises the lens module plate that takes the integrated design for waterproofing and optical purpose and is concise and in good appearance, which does not use the glass plate to separate the lens from the external part, and it may still achieve better waterproof effect;

3) Lens in the lens module plate is the polarized light distribution lens, which can bring about polarized light distribution applicable to lighting for large angle and scope so as to disperse the light for irradiation and enlarge the lighting area;

4) The radiator is provided with the holes for interconnecting the lower and upper parts of the radiator to form convection, which is convenient for heat exchange, and achieve good heat dissipation; and

5) The power supply is provided with a lightning arrester, which can improve the safety so as to extend service life of the LED lamp.

### BRIEF DESCRIPTION OF THE DRAWINGS

FIG. 1 is a schematic view of the LED lamp of the invention;

FIG. 2 is another schematic view of the LED lamp of the invention;

FIG. 3 is yet another schematic view of the LED lamp of the invention;

FIG. 4 is an exploded view of the LED lamp of the invention; (only the main components are indicated); and

FIG. 5 is a view of the LED lamp of the invention.

### DETAILED DESCRIPTION OF THE INVENTION

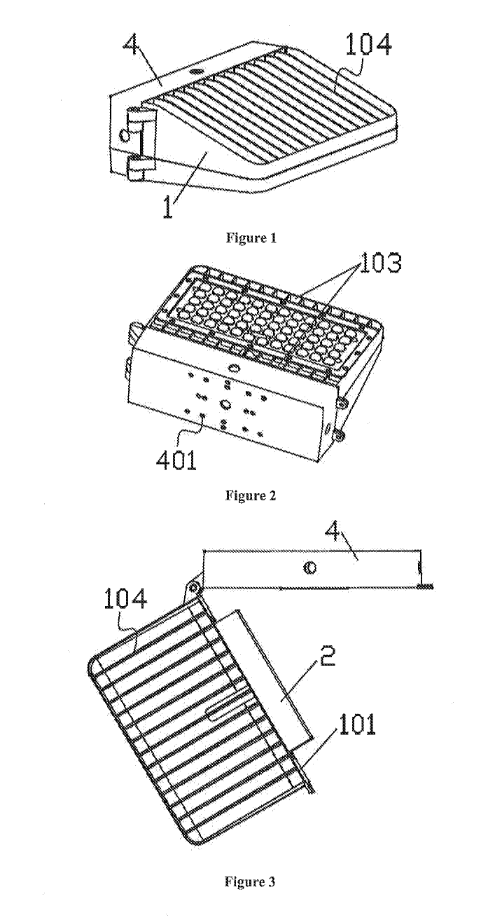

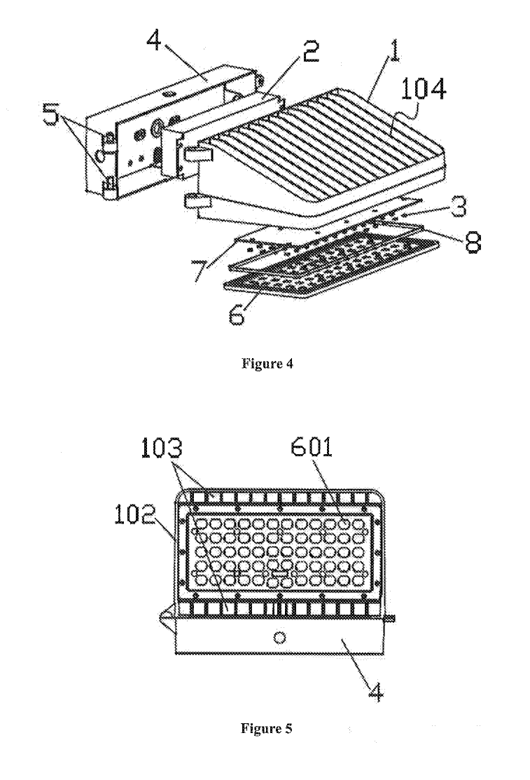

To better understand this invention, detailed description of the present invention are set forth below in conjunction with the accompany drawings. Referring to FIGS. 1, 2, 3, 4 and 5, an LED lamp of this invention mainly comprise a radiator 1, a power supply 2, a plurality of LED light sources 3. The power supply 2 is electrically connected with the LED light sources 3, the power supply 2 is installed at back 101 of the radiator 1, the power supply box 4 covers the power supply 2 and is fixedly secured to the back 101 of the radiator 1. One end of the power supply box 4 is movably connected with one end of the back 101 of the radiator 1 by, for example, a the rotating shaft 5, the other end of the power supply box 4 is fixed to the other end of the back 101 of the radiator 1 by a fastener (not shown in the figures). Based on such designs, it is convenient for opening the power supply box and is easy for dismounting and installing the power supply.

In order to install the LED lamp to the wall, the power supply box 4 is provided with a installation hole 401 for installing the LED lamp to the wall.

The LED lamp further comprises a lens module plate 6 and a heat conduction plate 7. The LED light sources 3 are homogenously distributed on the heat conduction plate 7, for example, the LED light sources 3 homogenously can be welded to the heat conduction plate 7. The heat conduction plate 7 is fixed to the bottom 102 of radiator. The quantity of lens 601 in the lens module plate 6 is equal to that of LED light sources 3. The lens module plate 6 covers the LED light sources 3 and is sealed by a waterproof ring 8, in which each lens covers each LED light source respectively. The lens module plate 6 is fixed to the bottom 102 of the radiator. The lens module plate 6 takes the integrated design for waterproofing and optical purpose and is concise and in good appearance. It is not necessary to use the glass plate to separate the lens from the external part, and it still can reach good waterproof effect.

The lens 601 in the lens module plate is the polarized light distribution lens, which can bring about polarized light distribution applicable to lighting for large angle and scope so as to disperse the light for irradiation and enlarge the lighting area.

The radiator 1 is provided with a hole 103 for interconnecting the lower and upper parts of the radiator 1 to form convection, thus it is convenient for heat exchange, and the heat dissipation is good. In addition, the radiator 1 is provided with several radiating fins 104 spaced by gaps therebetween so that it can accelerate heat dissipation. Preferably, the radiator 1 is made of aluminum or copper so that it can accelerate heat dissipation.

To strengthen the lightning protection effect of the LED lamp, improve the safety and extend the service life of the LED lamp, the power source 2 can be provided with a lightning arrester (not shown in the figures.)

The LED lamp of this invention can be easily dismounted and installed, whose structure is concise. And The LED lamp has the advantages of good waterproof effect, large illumination area, good heat dissipation, high safety and long service life.

The aforementioned are only preferred embodiments of the present invention, and shall not be intended to limit the invention. It should be noted that for those skilled in the art, any modifications, equivalent replacements or improvements, etc., made in the essence and principles of this invention should be included in the protection scope of this invention.

What is claimed is:

1. An LED lamp which comprises:
a radiator;
a power supply having a power supply box; and
a plurality of LED light sources electrically connected with the power supply; wherein the power supply is installed at the back of the radiator; and
the power supply is covered by the power supply box which is fixedly secured on the back of the radiator.

2. The LED lamp according to claim 1, wherein one end of the power supply box is movably connected with one end of the back of the radiator, and the other end of the power supply box is fixedly secured to the other end of the back of the radiator by fasteners.

3. The LED lamp according to claim 2, wherein one end of the power supply box is movably connected with one end of the back of the radiator via the rotating shaft.

4. The LED lamp according to any one of claim 1, wherein the power supply box is provided with the installation hole for installing the LED lamp on a wall.

5. The LED lamp according to any one of claim 2, wherein the power supply box is provided with the installation hole for installing the LED lamp on a wall.

6. The LED lamp according to any one of claim 3, wherein the power supply box is provided with the installation hole for installing the LED lamp on a wall.

7. The LED lamp according to any one of claim 1, wherein the LED lamp also comprise:
a lens module plate
a heat conduction secured on the bottom of the radiator plate, on which the LED light sources are homogenously distributed; and wherein
the lens quantity in the lens module plate is equal to the quantity of LED light sources;
the LED light sources is covered by the lens module plate, and is sealed by a waterproof ring, in which one LED light source is covered one lens cover in turn; and
the lens module plate is secured to bottom of the radiator.

8. The LED lamp according to any one of claim 2, wherein the LED lamp also comprise:
a lens module plate
a heat conduction secured on the bottom of the radiator plate, on which the LED light sources are homogenously distributed; and wherein
the lens quantity in the lens module plate is equal to the quantity of LED light sources;
the LED light sources is covered by the lens module plate, and is sealed by a waterproof ring, in which one LED light source is covered one lens cover in turn; and
the lens module plate is secured to bottom of the radiator.

9. The LED lamp according to any one of claim 3, wherein the LED lamp also comprise:
a lens module plate
a heat conduction secured on the bottom of the radiator plate, on which the LED light sources are homogenously distributed; and wherein
the lens quantity in the lens module plate is equal to the quantity of LED light sources;
the LED light sources is covered by he lens module plate, and is sealed by a waterproof ring, in which one LED light source is covered one lens cover in turn; and
the lens module plate is secured to bottom of the radiator.

10. The LED lamp according to claim 7, wherein the lens in the lens module plate is polarized light distribution lens.

11. The LED lamp according to claim 7, wherein the radiator is provided with a plurality of holes for interconnecting the lower and upper parts of the radiator.

12. The LED lamp according to claim 11, wherein the radiator is provided with a plurality of radiating fins, two of which is spaced by a gap therebetween.

13. The LED lamp according to claim 10, wherein the radiator is made of aluminum or copper.

14. The LED lamp according to claim 10, wherein the power supply is provided with a lightning arrester.
